(19) United States
(12) Patent Application Publication
(10) Pub. No.: US 2007/0112628 A1
(43) Pub. Date: May 17, 2007

(54) Distributing media files

(75) Inventor: Andrew W. Lombardo, Orange, CT (US)

Correspondence Address: Shirley S. Ma, Esq., P.O. Box 1065, S. Glastonbury, CT, 06033, US

(73) Assignee: Rockstar Technologies, L.L.C.

(21) Appl. No.: 11/471,864

(22) Filed: Jun. 21, 2006

Related U.S. Application Data
(60) Provisional application No. 60/695,919, filed on Jul. 2, 2005.

(51) Int. Cl. G06Q 30/00

(52) U.S. Cl. 705/14

(57) ABSTRACT

The present invention is directed to a system, method, and apparatus of downloading digital media files by a user wherein a computer user may download digital media files without incurring any charges whereby the computer user is subject to a targeted advertisement, in particular, during the file download time. Fees collected from advertisers can be used to offset the royalties due to rights holders of the digital media files such that the download is free for the user. Preferably, this system and apparatus can be used to disseminate digital media files such as music, books, artwork, video, games, ring tones, and multimedia works.

This application claims priority from U.S. Provisional Patent Application Ser. No. 60/695,919, filed on Jul. 2, 2005, herein incorporated by reference.

This invention is directed to a method and apparatus for distributing media files on a computer network by a user absent surcharges or payment, and without the need to provide personal information to third parties, thereby maintaining the user's privacy.

### BACKGROUND OF THE INVENTION

Beginning with the fall of Napster, the Recording Industry Association of America (RIAA), has attempted to rid the Internet of the use of peer-to-peer (P2P) file sharing programs to share copyrighted music recordings. File sharing programs such as that used by Napster and Kazaa were distributed to its users at no charge. Users would download copyrighted music for free from another user's computer, thereby circumventing the royalties owed to record companies and recording artists. Given the RIAA's limited success in suing P2P software distributors, the RIAA began pursuing individual users and their Internet Service Providers (ISPs) instead. Grandmothers and teenagers alike were sued for copyright infringement.

In order to limit the potential liability of downloading copyrighted music or other copyrighted material from the Internet, many websites are available wherein the computer user pays for the download, and the fees generated are put towards royalties. Although payment for the downloaded song is typically nominal, the potential for fraud increases when sensitive financial information is passed through the Internet. Other websites that provide free music downloads are sponsored by advertisers. However, the computer user must provide private, personal information with varying degrees of detail to advertisers, which is repugnant to most users. Also, the artists on the free music download websites do not receive any royalties from either the website or the user.

Thus, there is a need to provide a system and method of distributing media files without liability and hassle to the end user, that preferably provides royalties to the artist or other rights owner.

### SUMMARY OF THE INVENTION

The present invention is directed to a method of downloading digital media files by a user comprising the steps of entering and storing the user's personal preferences; providing digital media files wherein such digital media files are owned by one or more rights holder; displaying an advertisement related to the user's personal preferences wherein such advertisement must be concluded prior to successfully downloading a selected digital media file; permitting the download of a selected digital media file by the user only upon the conclusion of the advertisement; and providing the rights holder with compensation for the download of the selected digital media file. Preferably, the user's personal information is kept confidential from third parties. In the step of providing one or more downloadable digital media files, such digital media files are selected from the group consisting of text files, music files, graphics files, ring tone files, and video files.

In another aspect, the present invention is directed to a method of targeted advertising comprising the steps of providing a database of media files downloadable by a computer user; providing one or more advertising campaigns; selecting an advertising campaign for viewing by a computer user in accordance to a user's preferences; displaying the selected advertising campaign to the computer user when the computer user initiates download of a selected media file; completing the download of the selected media file upon conclusion of the selected advertising campaign. The method may further include the step of compensating a rights holder of the media flies. During the step of displaying the selected advertisement, the user cannot circumvent the display prior to downloading the selected media file.

In yet another aspect, the present invention is directed to a server within a network of user computers, each computer capable of accessing an application written by a programmer and stored on the served, the server capable of providing targeted advertisements to one or more users, comprising means for entering, and searching user information stored on the server; means for storing and downloading digital media files owned by one or more rights holders; means for storing and displaying an advertisement to completion relating to a user's information prior to the user downloading a selected digital media file such that the user is not subject to fees for the download of the selected digital media file; and means for compensating the rights holders. The advertiser and/or the rights holder may search the user information. The server may further include means for calculating royalty payments to the rights holders; means for providing selected user information to an advertiser; and/or means for contacting selected users according to the user's information.

In still yet another aspect, the present invention is directed to a computer program product comprising a computer usable media having computer readable program code means embedded therein for downloading digital media files by a user, the computer readable program code means in the computer program product comprising computer readable program code means for causing a computer to enter and store a user's personal preferences; computer readable program code means for causing a computer to enter and store digital media files; computer readable program code means for causing a computer to enter and store one or more advertisement campaigns; computer readable program code means for causing a computer to allow a user to search the digital media files; computer readable program code means for causing a computer to download a selected digital media file to a user's computer; computer readable program code means for causing a computer to display an advertisement to conclusion on the user's computer during the download of a selected digital media file; computer readable program code means for causing a computer to permit the download of the selected digital media file only upon conclusion of the advertisement; and computer readable program code means for causing a computer to calculate a royalty owed to a rights holder of the downloaded digital media file.

In still yet another aspect, the present invention is directed to a computer program product comprising a computer usable media having computer readable program code means embedded therein for targeted advertisements, the computer readable program code means in the computer program product comprising computer readable program code means for causing a computer to store a database of digital media files downloadable by a computer user; computer readable program code means for causing a computer to select an advertisement campaign for viewing by the computer user in accordance with the user's preferences; computer readable program code means for causing a computer to display a selected advertisement when the user initiates download -of a selected media file; computer readable program code means for causing a computer to complete the download of the selected media file upon conclusion of the selected advertisement.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the description of the preferred embodiment(s) which follows taken in conjunction with the accompanying drawings in which:

FIG. 1 is a schematic representation of a system that may be used to practice the present invention.

FIG. 2 is a flow diagram depicting the process steps of the present invention

### DETAILED DESCRIPTION OF THE PREFERRED EMBODIMENT(S)

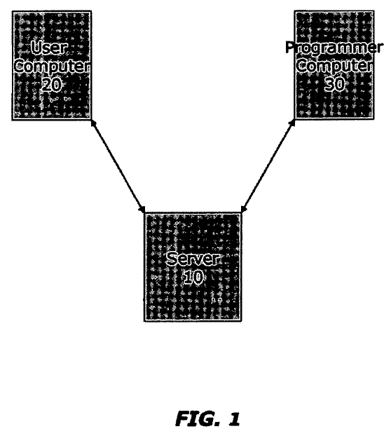

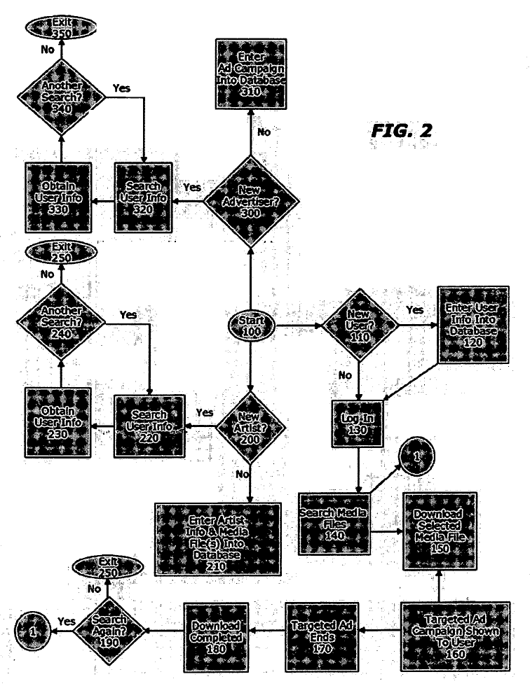

In describing the preferred embodiment of the present invention, reference will be made herein to FIGS. 1 to 2 of the drawings in which like numerals refer to like features of the invention. Features of the invention are not necessarily shown to scale in the drawings.

The present invention provides a method and apparatus for distributing digital media files wherein a computer user may download digital media files without incurring any charges whereby the computer user is subject to a targeted advertisement, in particular, during the file download time. Fees collected from advertisers are used to offset the royalties due to rights holders of the digital media files such that the download is free for the user. Demographic information about the computer users may also be collected and disseminated to the advertisers as well as the rights holders. Preferably, this system and apparatus can be used to disseminate digital media files such as , but not limited to, music, books, artwork, video, games, ring tones, and multimedia works.

One or more databases stored on a server or other electronic file storage device can be used to collect and maintain information about the users, the advertisers, and the rights holders; and the digital media files. The information can be readily accessible directly or remotely by the programmer, the user, the advertiser, and/or the rights holder using a computer terminal. Remote connection is available via the Internet. Preferably, an interface can be designed to provide guidance in navigating the databases. For example, the users can search the database through filters including, but not limited to, the name of the rights holder, types of files, or genre.

A programmer, in accordance with the method and apparatus of the present invention, can design a website according to known techniques in the art, that would allow the dissemination of the digital media files. The programmer may also be known as the webmaster. The one or more databases can be used to store user information such as, for example, name, address, password, email address, and user selected interests. Advertiser information may include the advertiser's contact information, the advertising campaigns, user key words targeted by the advertisers, and demographic information of all users that have viewed each of or, more broadly all, the advertising campaigns. Rights holders can store information such as the copyrighted work, and demographic information of all users that have downloaded each of or all of their copyrighted works. Preferably, a first database is used to store all user information, a second database is used to store all advertiser information, and a third database is used to store all the copyrighted works. Each database can be linked to each other or a single database can also be used to contain all information and file types. Design and maintenance of such databases are known to one of skill in the art.

In FIG. 1, an information system typically includes one computer system such as a server 10 that stores the digital media files, user information, and advertising campaigns and makes them available to other computer systems such as user computer 20 or programmer computer 30. Server 10 and computers 20 and 30 communicate via messages using a communications protocol sent over a communication channel such as a computer network, e.g., the Internet.

FIG. 2 is a flow diagram of the method steps of the present invention, wherein the application can be initiated 100 by a user, a rights holder, also referred to as an artist, or an advertiser. The application can be initiated by a new user 110 who is not in the user database. Therefore, the new user registers with the website by inputting such user data as personal information, email address, selecting a username and password, and selecting their interests and preferences. All such user information is entered into the user database 120. Upon successful registration, the user becomes a registered user. Once they were registered they would be able to log in 130 and search for the media files 140. The media files may be searched by key words, artist name, or media file name, for example. Upon downloading the selected media file 150, a targeted advertisement from a campaign provided by the advertiser is shown to the user during the file download 160. Upon termination of the targeted advertisement 170, the download of the media file is completed 180. During the download time, the user cannot conclude the targeted advertisement since the advertiser is “sponsoring” the download. In order to successfully download the media file, the targeted advertisement must run to completion. The targeted advertisement may contain a means for the user to contact the advertiser directly to obtain additional information on the service or product being advertised. After the media is successfully downloaded, the user is prompted 190 to search again. If the user chooses to search again, the user is directed back to search the media files 140. However, if the user chooses not to search again, the process ends and the user can log out of the system or close the application.

The process can also be initiated by the advertiser 100. New advertisers would provide the webmaster with one or more advertisement campaigns that would be shown to users during the file download. New advertisement campaigns would be entered into the advertiser database 310. Different advertisers may have different keywords for interests that they want to specify that correspond to the interests filled out by the user when registering. A registered advertiser may search the user database 320 and obtain demographic information on their target audience 330. The demographic information can be stored and reported back to the advertisers without breaching the confidentiality of any users. There would be no loss of privacy for the registered user since the user information would be kept in the database and would not be available to the advertiser. No personal contact information would be given to the advertiser. However, demographic information such as, but not limited to, income level, gender, profession, hobbies and other interests, can be provided to the advertiser. Should the advertiser seek further information from one or more users, the advertiser can contact the webmaster to request additional information from the selected registered users or the webmaster may provide an electronic mailing list, i.e., listserv, to the advertiser without divulging specific registered user email addresses. Upon obtaining the desired information, the advertiser is prompted to search again 340. Should the advertiser choose to search again under different criteria, the advertiser is directed back to search the registered user information 320. However, if the advertiser chooses not to search again, the process ends and the advertiser can log out of the system or close the application.

The rights holders or artists can also initiate the process of the present invention 100. New artists can register with the webmaster and their information and media files are stored into the database 210. The registered artists can also search the user database 220 to obtain information about the users who download their media files 230. Such information may be useful to an artist in targeting a market segment or formulating a market strategy. The application may also provide a means for the registered user to contact the artist directly. Alternatively, the application may provide a means for registered users to be contacted with updated artist information such as local appearances via an electronic mailing list. Again, the artist would not be privy to the personal information of the registered users. When the artist has acquired their desired information, the artist is prompted to search again 240. If the artist chooses to search again, the artist is directed back to search the registered user information 220. However, if the artist chooses not to search again, the process ends and the artist can log out of the system or close the application.

The present invention provides a method and apparatus for which media files can be downloaded by computer users at no expense wherein an advertiser “sponsors” the download by displaying a targeted advertisement to the user and wherein the monetary sponsorship compensates the artist for a limited license to use the media file. The advertiser can provide a targeted advertisement to potential and existing customers and gain valuable demographic information of those customers by linking the advertisement to the download of media files to computer users. Thus, artists or rights holders are fairly compensated and users are not liable for copyright infringement.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A method of downloading digital media files by a user comprising the steps of:
entering and storing the user's personal information wherein the user's personal information is kept confidential from third parties;
providing digital media files wherein such digital media files are owned by one or more rights holder;
displaying an advertisement related to the user's personal preferences wherein such advertisement must be concluded prior to successfully downloading a selected digital media file;
permitting the download of a selected digital media file by the user only upon the conclusion of the advertisement; and
providing the rights holder with compensation for the download of the selected digital media file.

2. A method of claim 1 wherein in the step of providing one or more downloadable digital media files, such digital media files are selected from the group consisting of text files, music files, graphics files, video files, and ring tone files

3. A method of targeted advertising comprising the steps of:
providing a database of media files downloadable by a computer user;
providing one or more advertising campaigns;
selecting an advertising campaign for viewing by a computer user in accordance to a user's preferences;
displaying the selected advertising campaign to the computer user when the computer user initiates download of a selected media file wherein the user cannot circumvent the display prior to downloading the selected media file;
completing the download of the selected media file upon conclusion of the selected advertising campaign; and
compensating a rights holder of the media files.

4. A method of claim 3 wherein in the step of providing a database of media files, such media files are selected from the group consisting of text files, music files, graphics files, video files, and ring tone files

5. A server within a network of user computers, each computer capable of accessing an application written by a programmer and stored on said served, said server capable of providing targeted advertisements to one or more users, comprising:
means for entering, and searching user information stored on said server by one or both of an advertiser and a rights holder;
means for storing and downloading digital media files owned by one or more rights holders;
means for storing and displaying an advertisement to completion relating to a user's information prior to the user downloading a selected digital media file such that the user is not subject to fees for the download of the selected digital media file;
means for compensating the rights holders;
means for providing selected user information to an advertiser.

6. A server of claim 5 wherein said means for storing and downloading digital media files, said digital media files are selected from the group consisting of text files, music files, graphics files, video files, and ring tone files

7. A computer program product comprising:
a computer usable media having computer readable program code means embedded therein for downloading digital media files by a user, the computer readable program code means in said computer program product comprising:
computer readable program code means for causing a computer to enter and store a user's personal preferences;
computer readable program code means for causing a computer to enter and store digital media files;
computer readable program code means for causing a computer to enter and store one or more advertisement campaigns;
computer readable program code means for causing a computer to allow a user to search the digital media files;
computer readable program code means for causing a computer to download a selected digital media file to a user's computer;
computer readable program code means for causing a computer to display an advertisement to conclusion on the user's computer during the download of a selected digital media file;
computer readable program code means for causing a computer to permit the download of the selected digital media file only upon conclusion of the advertisement; and
computer readable program code means for causing a computer to calculate a royalty owed to a rights holder of the downloaded digital media file.

8. A computer program product of claim 7 wherein said computer readable program code means for causing a computer to enter and store digital media files, said digital media files are selected from the group consisting of text files, music files, graphics files, video files, and ring tone files

9. A computer program product comprising:
a computer usable media having computer readable program code means embedded therein for targeted advertisements, the computer readable program code means in said computer program product comprising:
computer readable program code means for causing a computer to store a database of digital media files downloadable by a computer user;
computer readable program code means for causing a computer to select an advertisement campaign for viewing by the computer user in accordance with the user's preferences;
computer readable program code means for causing a computer to display a selected advertisement when the user initiates download of a selected media file;
computer readable program code means for causing a computer to complete the download of the selected media file upon conclusion of the selected advertisement.

10. A computer program product of claim 9 wherein said computer readable program code means for causing a computer to store a database of digital media files downloadable by a computer user, said digital media files are selected from the group consisting of text files, music files, graphics files, video files, and ring tone files
